(19) United States
(12) Patent Application Publication
(10) Pub. No.: US 2003/0008665 A1
(43) Pub. Date: Jan. 9, 2003

(54) Method and apparatus for providing travel instructions and related tracking information to a GPS capable wireless device

(75) Inventor: Charles Abraham, San Jose, CA (US)

Correspondence Address: Moser, Patterson & Sheridan, LLP, Attorneys At Law, Suite 100, 595 Shrewsbury Avenue, Shrewsbury, NJ, 07702, US

(73) Assignee: Global Locate Inc.

(21) Appl. No.: 09/971,065

(22) Filed: Oct. 4, 2001

Related U.S. Application Data
(60) Provisional application No. 60/303,659, filed on Jul. 6, 2001.

(51) Int. Cl. H04Q 7/20

(52) U.S. Cl. 455/456; 455/457

(57) ABSTRACT

A method and apparatus for providing travel instructions and related tracking information to a wireless device having position location capabilities. The apparatus comprises a position location aiding system, a travel information server, and a wireless device. The apparatus provides a user with travel instructions to a destination and tracks the user's travel along a route to the destination. The apparatus provides location information during travel only at such points during travel where such information is relevant to the user's travel along the route.

### CROSS-REFERENCE TO RELATED APPLICATIONS

This application claims benefit of U.S. provisional patent application serial No. 60/303,659, filed Jul. 6, 2001, which is herein incorporated by reference.

### BACKGROUND OF THE INVENTION

1. Field of the Invention

The present invention generally relates to position location systems. More particularly, the invention relates to a method and apparatus for providing travel instructions and related tracking information to a wireless device having position location capabilities.

2. Description of the Related Art

Positioning systems such as the global positioning system (GPS) have fostered numerous applications that involve tracking people and assets with devices that communicate to a network over wireless links. Various systems provide periodic location of a fixed asset, notification of proximity to pre-requested services, on-demand location identification, or continuous tracking of the location of a person or asset. Presently, such systems engage in access to a device being tracked on a schedule unrelated to the relevance of the tracking information. This results in tracking the device continuously, more frequently than necessary, or too infrequently to be effective. Continuous or too frequent access to the device results in the increased usage of “air time” and increased power consumption in the device. Accessing the device too infrequently results in decreased tracking performance.

Therefore, there exists a need in the art for a method and apparatus that efficiently provides travel instructions and related tracking information to users of wireless devices having position location capabilities.

### SUMMARY OF THE INVENTION

The present invention is a method and apparatus for providing travel instructions and related tracking information to a wireless device having position location capabilities. The apparatus of the present invention comprises a position location aiding system, a travel information server, and a wireless device. A user of the wireless device requests and receives travel instructions from the travel information server via a network, such as the Internet. In one embodiment, the travel instructions comprise a sequence of route instructions from a route origin to a route destination. Upon initiation of travel along the route, discrete locations of the wireless device are determined using satellite signals and location aiding information from the position location aiding system. When a particular location of the wireless device becomes route-critical, location information is communicated to the wireless device and displayed to the user to assure successful navigation of the route critical location.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of an apparatus for providing travel instructions and related tracking information to a position location enabled wireless device;

FIG. 2 shows a flow diagram of a method of delivering travel instructions and related tracking information to a wireless device; and

FIG. 3 illustrates a typical duty cycle of access to a wireless device relative to progress along a route.

### DETAILED DESCRIPTION OF THE PREFERRED EMBODIMENT

The present invention provides a method and apparatus for delivering travel instructions and related tracking information to a wireless device having position location capabilities. More specifically, the present invention provides location information during travel over a course of travel instructions, at and only at such points during travel where such information is of value to a user. In one embodiment, a user requests travel instructions from a travel information server via a wireless device or the Internet. In return, the user receives a sequence of route instructions detailing travel from the route origin to the route destination. During travel, the invention determines the user's location along the route at discrete intervals using the wireless device carried by the user. When the user's location corresponds to a route critical location, the invention transmits route guidance information in order to help the user successfully navigate critical route junctions. Transmitting the route guidance information only when it is of relevance to the user allows the present invention to mitigate “air time” charges associated with the wireless device, as well as power consumption of the wireless device.

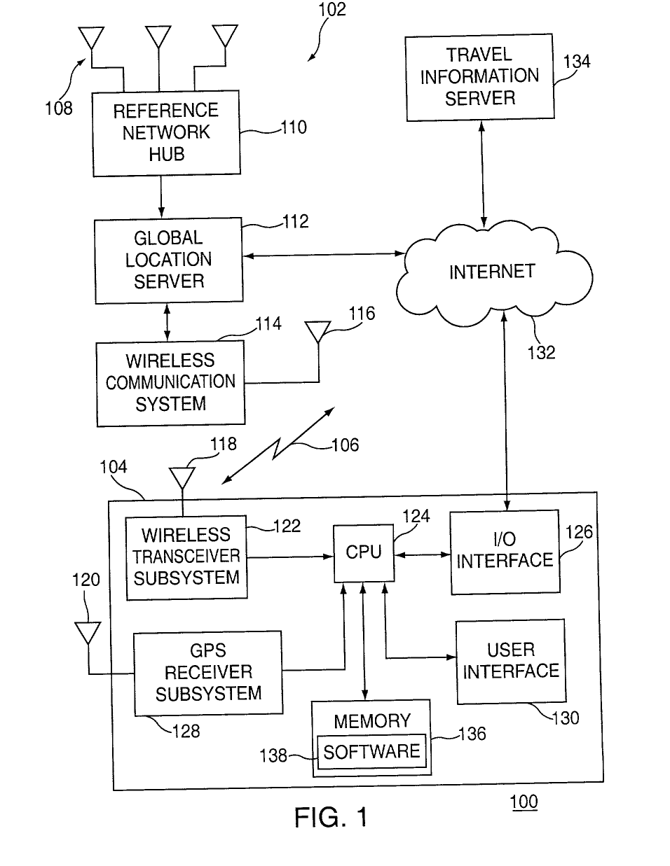

FIG. 1 depicts a block diagram of a system 100 for providing travel instructions and related tracking information to a wireless device in accordance with the present invention. The system 100 comprises a position location system 102, a travel information server 134, and a remote wireless device 104. The travel information server 134 contains map information and the like for providing travel instructions from a route origin to a route destination. Such travel information servers are well known in the art. The position location system 102 comprises an array of reference stations 108 positioned around the globe. The reference stations are coupled to the reference network 110, which collects the satellite position information for all the satellites in a constellation and sends that information to a global location server 112. The global location server is coupled to a wireless communication system 114 such as a cellular telephone system or a satellite paging system.

The wireless communication system 114 communicates with a plurality of wireless devices (for example, device 104) via antenna 116. Operation of the position location system 102 is described in U.S. patent application Ser. No. 09/553,930 filed Apr. 21, 2000 (attorney docket GLBL/002), entitled “METHOD AND APPARATUS FOR LOCATING AND PROVIDING SERVICES TO MOBILE DEVICES”, which is incorporated herein by reference. Operation of the reference network 110 and other embodiments of the position location aiding system 102 are described in U.S. patent application Ser. No. 09/615,105 filed Jul. 13, 2000 (attorney docket GLBL/005), entitled “METHOD AND APPARATUS FOR LOCATING MOBILE RECEIVERS USING A WIDE AREA REFERENCE NETWORK FOR PROPAGATING EPHEMERIS”, which is incorporated herein by reference. This position location system 102 provides position location services such that the wireless device 104 can compute its position or such that the wireless device 104 can supply measurements to a global location server 112 that computes the position of the wireless device 104.

The wireless communication system 114 is coupled to the remote wireless device 104 via a wireless communications link 106. The wireless device 104 is any two-way mobile device capable of using the wireless communication system 114 to transmit and receive a wireless signal to and from the global location server 112. Examples of such two-way wireless devices 104 include a two-way pager, a cellular telephone, and a personal digital assistant (PDA) device. The remote device 104 comprises a conventional wireless transceiver subsystem 122, a conventional position location receiver subsystem 128, a central processing unit (CPU) 124, input/output (I/O) interface 126, user interface 130, and memory 136.

The wireless transceiver subsystem 122 is coupled to wireless antenna 118 for communication with the wireless communications system 114. The position location receiver subsystem 128 is, for example, a global positioning system (GPS) receiver subsystem adapted for use with the position location system 102 as described above. Those skilled in the art will realize, however, that any position location receiver subsystem may function in this device, including, receiver subsystems for such satellite-based position location systems as GLONASS and GALILEO. The invention is described below with respect to the GPS position location system 102.

The GPS receiver subsystem 128 is coupled to a GPS antenna 120 for receiving satellite signals from the GPS satellites (not shown). GPS receiver subsystem provides all of the well-known front-end functionality as well as the correlation functions of a GPS receiver. The output of the GPS receiver subsystem 128 and the output of the wireless transceiver subsystem 122 are coupled to the CPU 124.

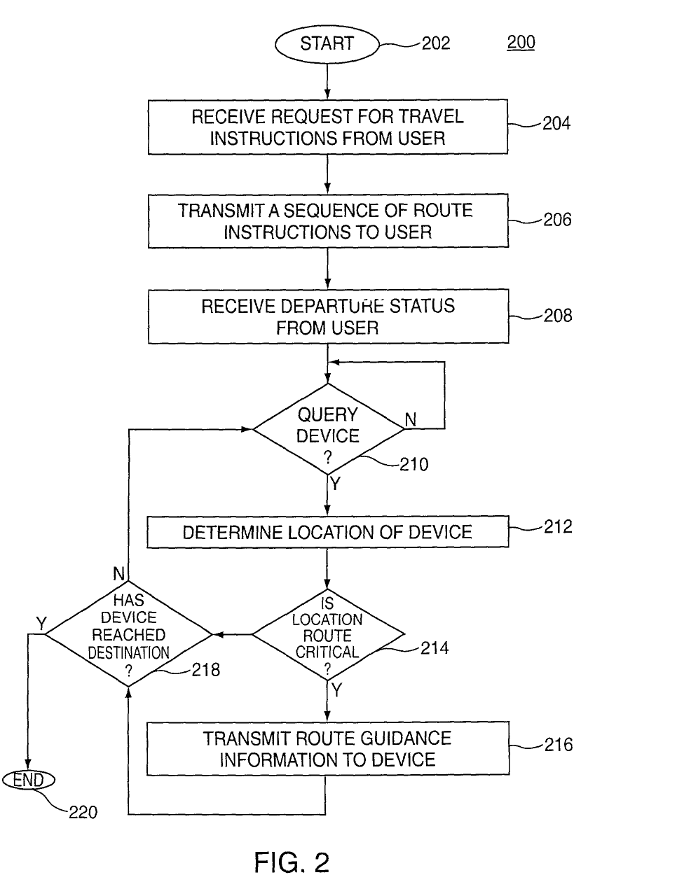

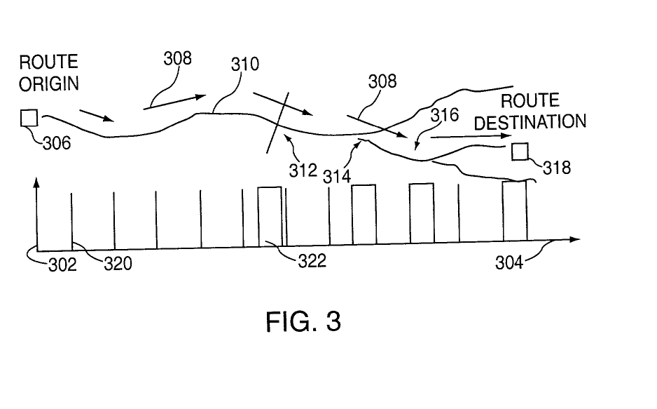

The CPU 124 is supported by the input/output (I/O) interface 126, the user interface 126, and the memory 136. The memory 136 stores software 138 that is executed by the CPU 124 to facilitate operation of the remote wireless device 104. A method for implementing the embodiment of FIG. 1 is further described with respect to FIGS. 2 and 3. Returning to FIG. 1, the I/O interface 126 is coupled with a network 132 such as the Internet for receiving travel information from the travel information server 134. The user interface 130 comprises any interface associated with cellular telephones, two-way pagers, and PDA devices, including an aural interface, a text-based messaging interface, and/or a graphical user interface.

The method of delivering travel instructions and related tracking information to the wireless device is described below with reference to FIGS. 2 and 3. Specifically, FIG. 2 depicts a flow diagram of a method for delivering travel instructions and related tracking information to a wireless device having position location capabilities. FIG. 3 depicts the duty cycle of access to the wireless device relative to progress along an exemplary route. The method of FIG. 2 can be implemented as software 138 that is executed in the wireless device 104. Alternatively, those skilled in the art understand that portions of the method of FIG. 2 can be implemented on the server side, such as in the global location server 112 or the travel information server 134.

The method 200 starts at step 202 and proceeds to step 204, where a request for travel instructions is received from a user. The request for travel instructions can be, for example, a request for a sequence of route instructions, accident reports, road conditions, weather, or like information related to travel. In one embodiment of the invention, the user can request the travel instructions via the wireless device 104, which can communicate with the travel information server 134 via the Internet 132 or the wireless communication system 116. Communication to the travel information server 134 through the wireless device 104 can be affected through voice, text based messaging, or a graphical web interface.

At step 206, the requested travel instructions are transmitted to the user. In the present embodiment, the user receives the travel instructions using the wireless device 104. The wireless device 104 comprises, for example, a PDA device or “smart phone” that is capable of downloading travel instructions through the Internet 132 from the travel information server 134 using a docking cradle or wireless link. Alternatively, the wireless device 104 can receive the travel information from the travel information server 134 through the wireless communication system 116.

In alternative embodiment of the invention, the user requests travel instructions at step 204 through devices other than the wireless device 104. For example, the user could connect to an Internet web site using a general-purpose computer to request the travel instructions. In this embodiment, the travel instructions are transmitted to the user at step 206 via the Internet and are saved, for example, in printed form. In addition, the user could request and receive travel instructions by speaking directly with a human operator. The human operator would receive the travel instructions from the travel information server 134 and communicate the travel instructions to the user.

In either embodiment, FIG. 3 illustrates an exemplary set of travel instructions. The travel instructions comprise a sequence of route instructions 308 detailing travel along a route 310 from a route origin 306 to a route destination 318. In this exemplary route, travel proceeds along route 310, through intersection 312, along the right branch of fork 314, and along the left branch of fork 316 to the route destination 318.

Once the user requests and receives the travel instructions, the user indicates departure status at step 208. The user indicates departure status by either affirmatively contacting the position location system 102 or by initiating travel upon the route 310 (i.e., upon initiation of travel, the method will assume the user has departed). In either case, when the user begins travel along the route 310, the position location system 102 begins tracking the location of the wireless device 104. Specifically, at step 210 the method 200 determines whether or not to query the wireless device 104 for its location. Location queries are performed at discrete intervals along the route 310. In one embodiment, the position location aiding system 102 determines the location of the wireless device 104 periodically as the wireless device 104 travels along the route 310. As described below, the duration of the location query is minimized at non-critical locations along the route 310.

At step 212, the location of the wireless device 104 is determined at the calculated time. Specifically, the GPS receiver subsystem 128 uses aiding information from the global location server 112 and signals received from GPS satellites (not shown) to calculate the location of the wireless device 104. At step 214, the method 200 determines whether the location calculated in step 212 is a route-critical location along the route 310. Route-critical locations comprise one or more of any position related events relevant to travel along route 310 such as, for example, approaching intersection 312, approaching forks 314 and 316, or deviating from the route instructions. Route-critical locations can be determined from a single location, or from a sequence of locations. For example, a route-critical location could encompass a pair of locations that together indicate a deviation from the route instructions.

If the current location of the wireless device 104 is not route critical, then the method 200 proceeds to step 218 to determine if the wireless device 104 has reached the route destination 318. If so, the method 200 precedes to end step 220. If the wireless device 104 is still traveling along the route 310, then the method 200 proceeds to step 210 to wait for another location query.

Although the method 200 has been described with periodic location queries, those skilled in the art understand that the present invention can also determine the location aperiodically using route-critical locations. Specifically, the position location system 102 can determine the location of the wireless device 104 aperiodically using an algorithm to compute the time interval between location queries. The algorithm could calculate the velocity of the wireless device and then use the velocity, a last known position, and a next route-critical position to calculate when the next location query should be.

In any case, if the current location of the wireless device 104 is route-critical, the method 200 proceeds instead to step 216. At step 216, route guidance is transmitted to the wireless device 104. Route guidance comprises a communication to the wireless device 104 that assists the user in navigating the route 310. For example, in one embodiment, route-critical locations comprise locations where the wireless device 104 has deviated from the route 319. If the wireless device 104 deviates from the route, the method 200 precedes from step 214 to step 216, where a communication is transmitted to the wireless device 104 alerting the user of the missed instruction and proposing a next action, such as a corrective sequence of route instructions. If the wireless device 104 never deviates from the route 310, then step 216 is never reached, and route guidance is not transmitted. In this manner, the present invention greatly reduces airtime usage of the wireless device 104.

In an alternative embodiment, route-critical locations comprise intersection 312, fork 314, and fork 316. When the wireless device 104 approaches one of the route-critical locations, for example intersection 312, then the device 104 receives a communication alerting the user of the intersection 312 and instructions on how to navigate through the intersection 312 in order to stay on the route 310. As described above, route-critical locations comprise one or more of any position related events relevant to travel along route 310 not limited to the above embodiments. Furthermore, route guidance can comprise various communications that can help a user navigate through such a route-critical location. Thus, those skilled in the art could readily devise other useful configurations of route-critical locations and route guidance that are within the scope of the present invention.

The route guidance information transmitted at step 216 can be in various communication forms, including aural messages, text-based messaging, or graphical interface messages. Such communications can be automated responses or interactive communications from a human operator. The form of the communication depends upon the form of the user interface 130 of the wireless device 104. At step 218, the method 200 determines if the wireless device 104 has reached the route destination 318. If so, the method 200 proceeds to end step 220. If the wireless device 104 is still traveling along the route 310, then the method proceeds to step 210 to wait for another location query.

The duty cycle of access to the wireless device 104 is depicted below the route 310 in FIG. 3. In this exemplary duty cycle, the device 104 is queried periodically as described above. Axis 302 represents the power expended by the device 104 and axis 304 represents time. When the user is traveling through non-critical route locations, only the location of the device 104 is determined. This results in a standard minimum query 320. When the user approaches a route-critical location, such as intersection 312, route guidance information is transmitted to the device 104 as described above. This results in a longer duration query 322 of the device 104 as needed to confirm successful navigation of the route-critical location. Thus, airtime usage and power consumption are kept to a minimum as the user is traveling through non-critical route locations. Tracking performance is increased, however, when the user approaches a location that is critical to successful navigation.

An additional advantage of the invention is that users will not be distracted by route guidance information when traveling though non-critical route locations. For example, in the embodiment where route guidance is provided only when the user deviates from the route 310, the user is not distracted by route guidance information at all unless the user deviated from the route. Furthermore, the present invention can also be configured to provide the user with the capability to request route guidance information at any time using the wireless device 104. In this manner, the user can re-verify that they have not deviated form the route 310 and can reconfirm future maneuvers.

While foregoing is directed to the preferred embodiment of the present invention, other and further embodiments of the invention may be devised without departing from the basic scope thereof, and the scope thereof is determined by the claims that follow.

1. A method of guiding a user of a position location enabled wireless device along a route comprising:
transmitting a request for travel instructions from the user to a travel information server;
transmitting, in response to the request, the travel instructions from the travel information server to the user for navigation of the route;
determining one or more discrete locations of the wireless device along the route; and
transmitting route guidance information to the wireless device if a particular location of the one or more discrete locations is a route-critical location.

2. The method of claim 1 wherein the step of determining one or more discrete locations of the wireless device comprises periodically determining a plurality of discrete locations of the wireless device along the route.

3. The method of claim 1 wherein the step of determining one or more discrete locations of the wireless device comprises aperiodically determining a plurality of discrete locations of the wireless device along the route, wherein the interval between each discrete location of the plurality of discrete locations and the location preceding each discrete location of the plurality of discrete locations is calculated using a velocity of the wireless device and the preceding location.

4. The method of claim 1 wherein the step of determining one or more discrete locations of the wireless device comprises:
providing satellite aiding data to the wireless device from a global positioning system (GPS) reference network; and
calculating the one or more discrete locations using the satellite aiding data in the wireless device.

5. The method of claim 1 wherein the step of determining one or more discrete locations of the wireless device comprises calculating the one or more discrete locations in a global location server.

6. The method of claim 1 wherein a route-critical location comprises at least one of an intersection, a fork in the route, and a deviation from the route.

7. The method of claim 6 wherein the step of transmitting route guidance information to the wireless device comprises transmitting a corrective sequence of route instructions to the wireless device when the route-critical location signifies a deviation from the route.

8. The method of claim 1 wherein the step of transmitting route guidance information to the wireless device comprises providing a sequence of route instructions for navigating in proximity to a route-critical location.

9. An apparatus for guiding a user of a position location enabled wireless device along a route comprising:
a position location system for calculating one or more discrete locations of at least one remote wireless device
a travel information server for providing travel instructions for navigating the route; and
at least one remote wireless device having circuits for receiving route guidance information if a particular location of the one or more discrete locations is a route-critical location.

10. The apparatus of claim 9 wherein the position location system periodically calculates a plurality of locations along the route.

11. The apparatus of claim 9 wherein the position location system aperiodically calculates a plurality of locations along the route, the interval between each of the plurality of locations and the location preceding each of the plurality of locations being determined by a velocity of the at least one remote wireless device and the preceding location.

12. The apparatus of claim 9 wherein the position location system is a global positioning system (GPS) reference network.

13. The apparatus of claim 12 wherein the at least one remote wireless device further comprises circuits for receiving satellite aiding data from the GPS reference network.

14. The apparatus of claim 9 wherein the at least one remote wireless device further comprises a user interface for displaying the route guidance information.

15. The apparatus of claim 9 wherein the at least one remote wireless device further comprises an aural interface for providing the route guidance information.
